(19) United States
(12) Patent Application Publication
(10) Pub. No.: US 2025/0303884 A1
(43) Pub. Date: Oct. 2, 2025

(54) SYSTEM AND METHOD FOR CHARGING PLURALITY OF WORK MACHINES

(71) Applicant: Caterpillar Inc., Peoria, IL (US)

(72) Inventor: Pankaj Kumar, Peoria, IL (US)

(73) Assignee: Caterpillar Inc., Peoria, IL (US)

(21) Appl. No.: 18/616,650

(22) Filed: Mar. 26, 2024

(51) Int. Cl. B60L 53/10; B60L 53/16; B60L 53/18; B60L 53/66

(52) U.S. Cl. CPC B60L 53/11; B60L 53/16; B60L 53/18; B60L 53/66; B60L 2200/40

(57) ABSTRACT

A system for charging a plurality of work machines having different charging protocols includes a power supply unit, a first controller disposed within the power supply unit, and a charging arrangement to direct the electric power supply from the power supply unit to the work machines. The charging arrangement includes a plurality of cable assemblies. At a given instant of time, one of the work machines is connected with the power supply unit via a corresponding cable assembly from the cable assemblies to direct the electric power supply from the power supply unit to one of the work machines. Alternatively, the charging arrangement includes an adapter. The adapter includes a housing, an inlet, a plurality of outlet ports, and a second controller configured to determine a charging protocol of one of the plurality of work machines that is currently connected with the adapter.

### TECHNICAL FIELD

The present disclosure relates to a system and a method for charging a plurality of work machines.

### BACKGROUND

Work machines that employ battery systems as their main source of power have to be periodically recharged. Such battery systems typically require a direct current power supply for recharging. Currently, different manufacturers of work machines use their own customized charging protocol or standard along with a customized connector for charging the work machines. However, at a worksite, a customer may employ work machines from different manufacturers. In such situations, customers are required to have different types of charging systems to charge the respective work machine. For example, one work machine may employ a charging protocol and a connector that may be different from a charging protocol and a connector of another work machine.

Currently there is no dedicated charging protocol that can be implemented by all work machines for charging of battery systems. To have a dedicated charging system for each manufacture's work machine is costly in terms of purchasing costs as well as handling costs of separate charging systems. Further, a larger space is required to store different charging systems. Moreover, customers may incur additional costs to have a dedicated charging infrastructure for each type of charging system.

CN111546926A describes a charging system supporting multiple charging protocols and a control method thereof, the charging system comprises a direct current charging pile, a charging connector converter and a charging connector library, and the direct current charging pile outputs direct current and performs electric vehicle charging adaptive communication; the charging connector converter is used for switching circuits between different charging connectors and the direct-current charging pile; and a plurality of charging heads with different interface standards are arranged in the charging connector library. The system is simple and feasible in application and convenient to control. Multiple charging protocols can be supported on the basis of not changing existing direct-current charging pile hardware, the charging compatibility of various electric vehicles is improved by changing the charging connector library and the charging connector converter and updating the charging management protocol, and the multi-charging-protocol direct-current charging pile has great production practice significance.

### SUMMARY OF THE DISCLOSURE

In an aspect of the present disclosure, a system for charging a plurality of work machines is provided. At least some of the plurality of work machines have different charging protocols. The system includes a power supply unit adapted to direct an electric power supply to the plurality of work machines. The system also includes a first controller disposed within the power supply unit and configured to control the power supply unit to deliver the electric power supply to one of the plurality of work machines based on the charging protocol of one of the plurality of work machines. The system further includes a charging arrangement adapted to direct the electric power supply from the power supply unit to the plurality of work machines. The charging arrangement includes a plurality of cable assemblies. At a given instant of time, one of the plurality of work machines is adapted to be connected with the power supply unit via a corresponding cable assembly from the plurality of cable assemblies to direct the electric power supply from the power supply unit to one of the plurality of work machines. Alternatively, the charging arrangement includes an adapter. The adapter includes a housing. The adapter also includes an inlet port defined in the housing. The power supply unit connects with the adapter via the inlet port. The adapter further includes a plurality of outlet ports defined in the housing. The adapter is adapted to connect with each of the plurality of work machines via a corresponding outlet port from the plurality of outlet ports. The adapter includes a second controller disposed in the housing. The second controller is communicably coupled with the first controller and the plurality of work machines. The second controller is configured to determine the charging protocol of one of the plurality of work machines that is currently connected with the adapter. The second controller is also configured to transmit information of the charging protocol of one of the plurality of work machines to the first controller. Further, the first controller is configured to control the power supply unit to deliver the electric power supply to one of the plurality of work machines as per the charging protocol of one of the plurality of work machines.

In another aspect of the present disclosure, a method of charging a plurality of work machines is provided. At least some of the plurality of work machines have different charging protocols. The method includes providing a power supply unit adapted to direct an electric power supply to the plurality of work machines. The method also includes connecting, via a charging arrangement, the power supply unit with one of the plurality of work machines. The charging arrangement includes a plurality of cable assemblies. At a given instant of time, one of the plurality of work machines is adapted to be connected with the power supply unit via a corresponding cable assembly from the plurality of cable assemblies to direct the electric power supply from the power supply unit to one of the plurality of work machines. Alternatively, the charging arrangement includes an adapter. The adapter includes a housing, an inlet port defined in the housing, and a plurality of outlet ports defined in the housing. The power supply unit connects with the adapter at the inlet port. The adapter is adapted to connect with each of the plurality of work machines via a corresponding outlet port from the plurality of outlet ports. The method further includes determining, by a first controller disposed within the power supply unit, the charging protocol of one of the plurality of work machines that is currently connected with the power supply unit. The first controller is configured to determine the charging protocol of one of the plurality of work machines via the charging arrangement. The method includes controlling, by the first controller, the power supply unit to deliver the electric power supply to one of the plurality of work machines based on the charging protocol of one of the plurality of work machines. The method also includes directing, via the charging arrangement, the electric power supply from the power supply unit to one of the plurality of work machines.

Other features and aspects of this disclosure will be apparent from the following description and the accompanying drawings.

### BRIEF DESCRIPTION OF THE DRAWINGS

FIG. 1 illustrates a number of machines associated with an exemplary machine fleet;

FIG. 2 is a schematic view of a system for charging the number of work machines of FIG. 1 using a first type of charging arrangement, according to an embodiment of the present disclosure;

FIG. 3 is a block diagram of the system of FIG. 2;

FIG. 4 is a schematic view of a system for charging the number of work machines of FIG. 1 using a second type of charging arrangement, according to another embodiment of the present disclosure;

FIG. 5 is a block diagram of the system of FIG. 4; and

FIG. 6 is a flowchart for a method of charging a plurality of work machines, according to an embodiment of the present disclosure.

### DETAILED DESCRIPTION

Wherever possible, the same reference numbers will be used throughout the drawings to refer to the same or like parts.

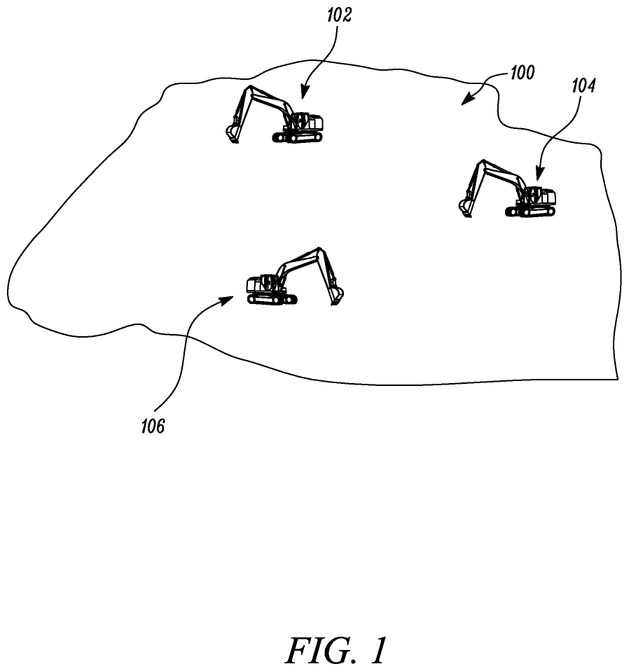

FIG. 1 illustrates a schematic view of a number of work machines 102, 104, 106 associated with an exemplary machine fleet 100. In the illustrated example of FIG. 1, each work machine 102, 104, 106 is embodied as an excavator. Alternatively, the work machines 102, 104, 106 may include a dozer, a tractor, a grader, a truck, or any other type of battery-operated machine. The work machines 102, 104, 106 may be of the same type or may be of different types. Further, the work machines 102, 104, 106 may be manufactured by different manufacturers.

Each work machine 102, 104, 106 includes a corresponding battery system (not shown herein). The battery system may need to be recharged as and when an amount of charging in the battery system reduces below a charging threshold. In an example, each battery system may require 48 Volts of direct current (DC) power supply, 72 V of DC power supply, 96 V of DC power supply for charging thereof. Further, at least some of the number of work machines 102, 104, 106 have different charging protocols. For example, the work machine 102 may employ a first charging protocol, the work machine 104 may employ a second charging protocol that is different from the first charging protocol, and the work machine 106 may employ a third charging protocol that is different from the first and second charging protocols. The charging protocol of each work machine 102, 104, 106 may vary as per a manufacturer of a corresponding work machine 102, 104, 106.

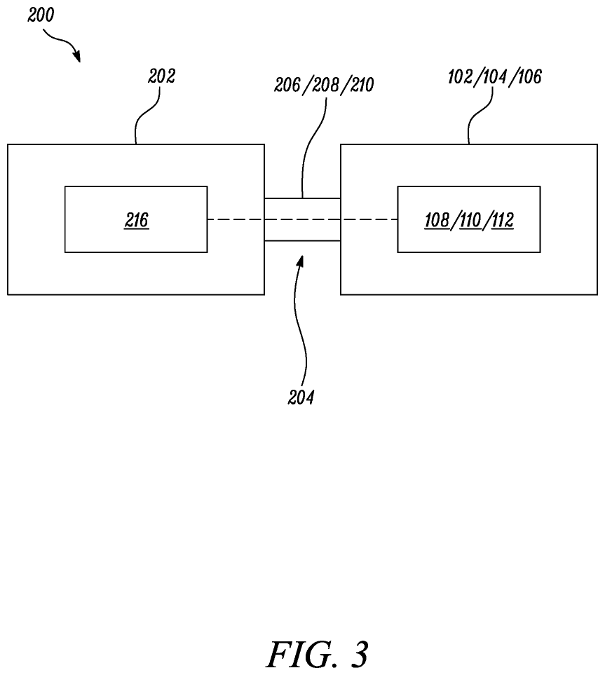

Further, each of the number of work machines 102, 104, 106 includes a machine controller 108, 110, 112 (shown in FIG. 3). Specifically, each work machine 102, 104, 106 includes a corresponding machine controller 108, 110, 112 present onboard the work machine 102, 104, 106. The machine controller 108, 110, 112 may include a memory that may store details related to charging requirements, charging standards, and/or charging protocols of the corresponding work machine 102, 104, 106. The machine controller 108, 110, 112 may communicate with other controllers/processors to provide details of the charging requirements, the charging standards, and/or the charging protocols of the corresponding work machine 102, 104, 106.

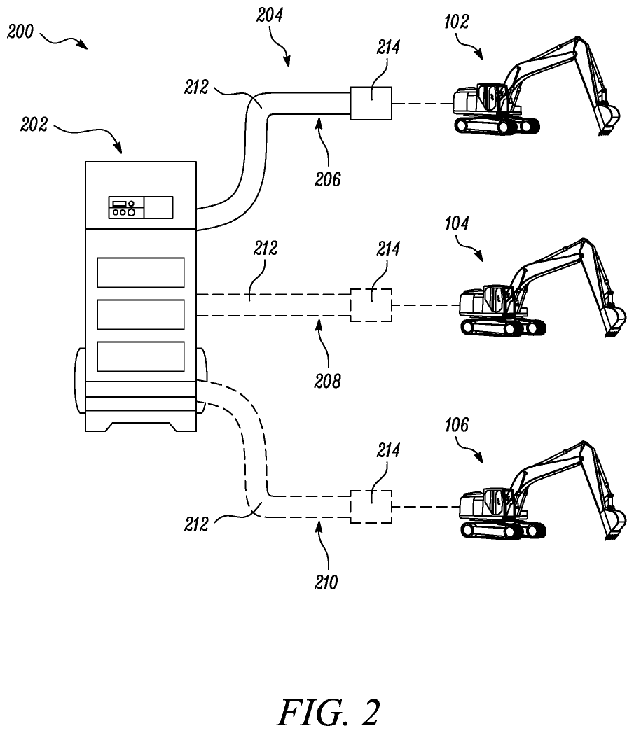

FIG. 2 is a schematic view of a system 200 for charging the number of work machines 102, 104, 106, according to an embodiment of the present disclosure. The system 200 includes a power supply unit 202 that directs an electric power supply to the number of work machines 102, 104, 106. In the illustrated embodiment of FIG. 2, the power supply unit 202 includes any one of a 48 V DC charger, a 72 V DC charger, and a 96 V DC charger. Thus, the power supply unit 202 may provide a 48 V DC power supply, a 72 V DC power supply, or a 96 V DC power supply to the work machines 102, 104, 106.

The system 200 also includes a charging arrangement 204 that directs the electric power supply from the power supply unit 202 to the number of work machines 102, 104, 106. In the illustrated embodiment of FIG. 2, the charging arrangement 204 includes a number of cable assemblies 206, 208, 210. At a given instant of time, one of the number of work machines 102, 104, 106 is connected with the power supply unit 202 via a corresponding cable assembly 206, 208, 210 from the number of cable assemblies 206, 208, 210 to direct the electric power supply from the power supply unit 202 to one of the number of work machines 102, 104, 106. Specifically, each cable assembly 206, 208, 210 may be used to charge a corresponding work machine 102, 104, 106 and may be compatible with the charging protocol of the corresponding work machine 102, 104, 106. Thus, the cable assembly 206, 208, 210 may be interchangeably connected with the power supply unit 202.

The charging arrangement 204 includes three cable assemblies 206, 208, 210 herein. However, a total number of the cable assemblies 206, 208, 210 may vary based on a total number of the work machines 102, 104, 106 and/or different charging protocols for the work machines 102, 104, 106. In the illustrated embodiment of FIG. 2, the cable assembly 206 is used to charge the work machine 102, the cable assembly 208 is used to charge the work machine 104, and the cable assembly 210 is used to charge the work machine 106. As an example, FIG. 2 illustrates the cable assembly 206 connected with the power supply unit 202.

Further, each of the number of cable assemblies 206, 208, 210 includes a cable 212 and an electric connector 214. The cable 212 is connected with a corresponding work machine 102, 104, 106 from the number of work machines 102, 104, 106 via the electric connector 214. Specifically, the electric connector 214 connects with a mating electric connector (not shown herein) disposed in the corresponding work machine 102, 104, 106 to connect the cable assembly 206, 208 210 with the corresponding work machine 102, 104, 106. The mating electric connector may be disposed within a chassis of the corresponding work machine 102, 104, 106. A type of the electric connector 214 of each of the number of cable assemblies 206, 208, 210 is selected as per the charging protocol of the corresponding work machine 102, 104, 106. In other words, the cable 212 and the electric connector 214 of each cable assembly 206, 208, 210 may be compatible with the charging protocol of the corresponding work machine 102, 104, 106. In an example, the cable 212 and the electric connector 214 may be same for the work machines 102, 104, 106. In another example, the cable 212 and the electric connector 214 may be different for each work machine 102, 104, 106.

Referring now to FIGS. 2 and 3, the system 200 further includes a first controller 216 disposed within the power supply unit 202. The first controller 216 controls the power supply unit 202 to deliver the electric power supply to one of the number of work machines 102, 104, 106 based on the charging protocol of one of the number of work machines 102, 104, 106.

Further, the first controller 216 of the power supply unit 202 communicates with the machine controller 108, 110, 112 of each work machine 102, 104, 106 via the corresponding cable assembly 206, 208, 210. For example, the first controller 216 communicates with the machine controller 108 of the work machine 102 via the cable assembly 206, the first controller 216 communicates with the machine controller 110 of the work machine 104 via the cable assembly 208, and the first controller 216 communicates with the machine controller 112 of the work machine 106 via the cable assembly 210. It should be noted that each cable 212 of the corresponding cable assembly 206, 208, 210 may include one or more cables that direct the electric power supply from the power supply unit 202 to the battery system of the corresponding work machine 102, 104, 106. Moreover, each cable 212 of the corresponding cable assembly 206, 208, 210 may include one or more communication cables that communicably connect the first controller 216 with the machine controller 108, 110, 112 in order to facilitate exchange of information between the first controller 216 and the machine controller 108, 110, 112. A connection between the first controller 216 and the machine controller 108, 110 is illustrated by a dotted line in FIG. 3.

Further, when the charging arrangement 204 includes the number of cable assemblies 206, 208, 210, the first controller 216 determines a connection of one of the number of work machines 102, 104, 106 with the power supply unit 202 via the corresponding cable assembly 206, 208, 210 from the number of cable assemblies 206, 208, 210. Moreover, the first controller 216 determines the charging protocol of the work machine 102, 104, 106 that is currently connected with the power supply unit 202. Specifically, the first controller 216 receives information of the charging protocol of the work machine 102, 104, 106 from the machine controller 108, 110, 112 to determine the charging protocol of the work machine 102, 104, 106. Further, the first controller 216 configures the electric power supply to the work machine 102, 104, 106 that is currently connected with the power supply unit 202 as per the charging protocol of the work machine 102, 104, 106. In other words, the first controller 216 adapts to the charging protocol or charging standards of the work machine 102, 104, 106 to meet the charging requirements of the work machine 102, 104, 106.

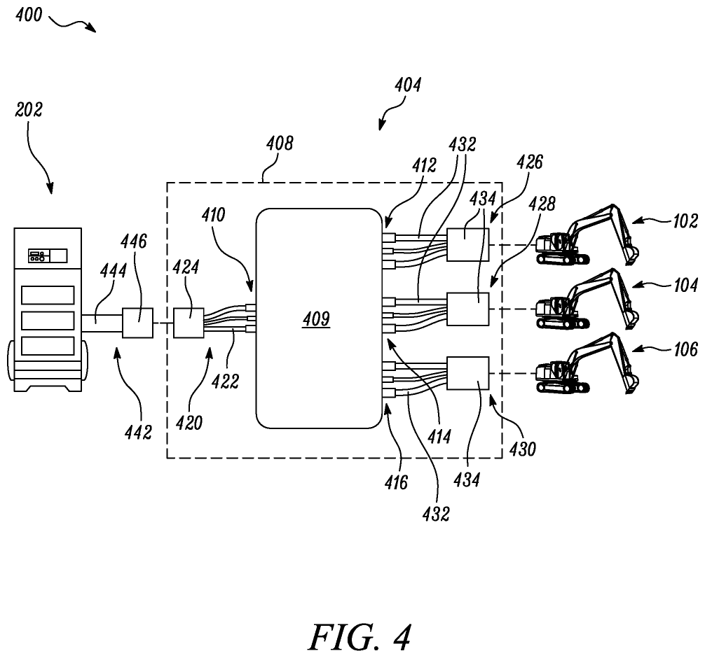

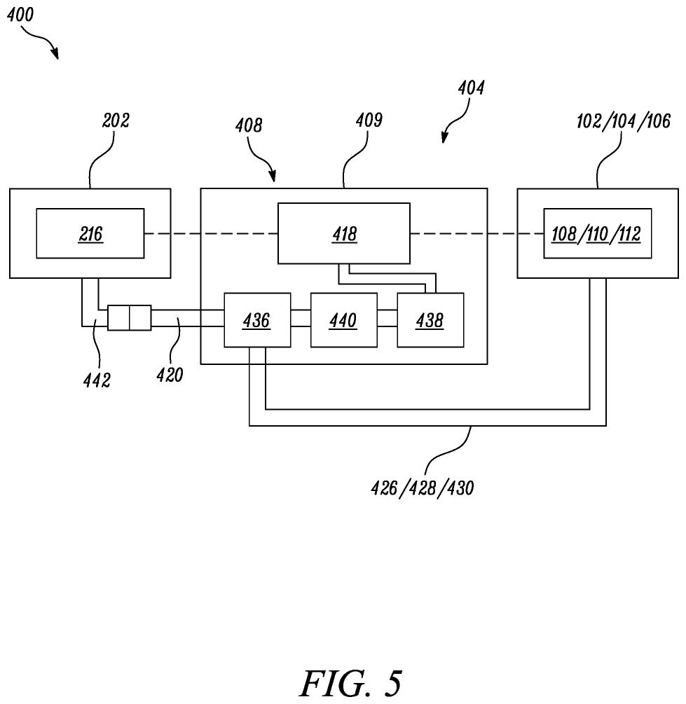

FIG. 4 is a schematic view of a system 400 for charging the number of work machines 102, 104, 106, according to another embodiment of the present disclosure. The system 400 includes the power supply unit 202 that is same as that explained in relation to FIGS. 2 and 3. The system 400 also includes the first controller 216 (see FIG. 5) that is same as that explained in relation to FIGS. 2 and 3. The system 400 further includes a charging arrangement 404 that directs the electric power supply from the power supply unit 202 to the number of work machines 102, 104, 106. In the illustrated embodiment of FIG. 4, the charging arrangement 404 includes an adapter 408. The adapter 408 may allow connection of multiple work machines 102, 104, 106 with the power supply unit 202. Further, at a given instant of time, any one of the work machines 102, 104 106 may be connected with the power supply unit 202 via the adapter 208 to direct the electric power supply from the power supply unit 202 to any one of the work machines 102, 104 106.

The adapter 408 includes a housing 409. The adapter 408 also includes an inlet port 410 defined in the housing 409. The power supply unit 202 connects with the adapter 408 via the inlet port 410. The adapter 408 further includes a number of outlet ports 412, 414, 416 defined in the housing 409. The adapter 408 connects with each of the number of work machines 102, 104, 106 via a corresponding outlet port 412, 414, 416 from the number of outlet ports 412, 414, 416. A total number of the outlet ports 412, 414, 416 may vary as per a number of charging protocols associated with the work machines 102, 104, 106. In an example, the adapter 408 may include three outlet ports 412, 414, 416 to connect with three different work machines 102, 104, 106 having three different charging protocols. The adapter 408 further includes a second controller 418 (shown in FIG. 5) disposed in the housing 409. The second controller 418 is communicably coupled with the first controller 216 and the number of work machines 102, 104, 106. Specifically, at any given instant of time, the second controller 418 may be communicably coupled with the machine controller 108, 110, 112 (see FIG. 5) of any one work machine 102, 104, 106. The second controller 418 may be disposed within the housing 409.

When the charging arrangement 404 includes the adapter 408, the charging arrangement 404 further includes a first cable assembly 442 that connects with the power supply unit 202. In an example, the first cable assembly 442 may be a part of the power supply unit 202. The first cable assembly 442 includes a cable 444 and an electric connector 446. Further, the adapter 408 includes a second cable assembly 420 that connects the inlet port 410 of the adapter 408 with the first cable assembly 442. In other words, the first cable assembly 442 connects with the second cable assembly 420 to connect the power supply unit 202 with the inlet port 410. The second cable assembly 420 includes a cable 422 and an electric connector 424. The electric connector 446 connects with the electric connector 424 to connect the first cable assembly 442 with the second cable assembly 420.

Further, the first controller 216 of the power supply unit 202 communicates with the second controller 418 of the adapter 408 via the first and second cable assemblies 442, 420. It should be noted that the cable 444, 422 of each of the first and second cable assemblies 442, 420 may include one or more cables that directs the electric power supply from the power supply unit 202 towards an electric junction 436 of the adapter 408. Moreover, the cable 444, 422 of each of the first and second cable assemblies 442, 420 may include one or more communication cables that communicably connect the first controller 216 with the second controller 418 in order to facilitate exchange of information between the first controller 216 and the second controller 418. A connection between the first controller 216 and the second controller 418 is illustrated by a dotted line in FIG. 5.

As shown in FIG. 4, the adapter 408 further includes a number of third cable assemblies 426, 428, 430. One or more work machines 102, 104, 106 from the number of work machines 102, 104, 106 is connected with the corresponding outlet port 412, 414, 416 of the adapter 408 via a corresponding third cable assembly 426, 428, 430 from the number of third cable assemblies 426, 428, 430. Each of the number of third cable assemblies 426, 428, 430 includes a cable 432 and an electric connector 434. The electric connector 434 connects with the mating electric connector that is disposed in the corresponding work machine 102, 104, 106. A type of the electric connector 434 of each of the number of third cable assemblies 426, 428, 430 is selected as per the charging protocol of the corresponding work machine 102, 104, 106 from the number of work machines 102, 104, 106. In other words, the cable 432 and the electric connector 434 of each third cable assembly 426, 428, 430 may be compatible with the charging protocol of the number of work machines 102, 104, 106. In an example, the cable 432 and the electric connector 434 may be same across the third cable assemblies 426, 428, 430. In another example, the cable 432 and the electric connector 434 may be different for each third cable assembly 426, 428, 430.

Referring now to FIGS. 4 and 5, the adapter 408 further includes the electrical junction 436. The electrical junction 436 receives the electric power supply from the power supply unit 202. The electrical junction 436 is connected to the second cable assembly 420 via the inlet port 410. Further, the electrical junction 436 directs the electric power supply towards the battery system of the work machine 102, 104, 106 via the corresponding third cable assembly 426, 428, 430. The electrical junction 436 is connected to the corresponding third cable assembly 426, 428, 430 via the corresponding outlet port 412, 414, 416.

The adapter 408 further includes a battery 438 that directs an operating power supply to the second controller 418 for operation thereof. The battery 438 is embodied as a rechargeable battery herein. The battery 438 is recharged based on receipt of a power supply from the power supply unit 202 upon connecting the power supply unit 202 with the adapter 408. Thus, when the adapter 408 is connected to the power supply unit 202, via the first and second cable assemblies 442, 420, the power supply from the power supply unit 202 charges the battery 438. Thus, the battery 438 is recharged by the power supply from the power supply unit 202 when the power supply unit 202 is connected to the adapter 408, and the battery 438 provides operating power supply to the second controller 418 when the power supply unit 202 is not connected to the adapter 408.

It should be noted that the power supply includes a portion of the electric power supply that is received by the electrical junction 436 from the power supply unit 202. The adapter 408 further includes a converter 440 disposed between the electrical junction 436 and the battery 438. The converter 440 converts the power supply received from the electrical junction 436 to a suitable form so as to recharge the battery 438. The electrical junction 436, the battery 438, and the converter 440 may be disposed within the housing 409.

Further, the second controller 418 of the adapter 408 communicates with the machine controller 108, 110, 112 of the number of work machines 102, 104, 106 via the corresponding third cable assembly 426, 428, 430. For example, the second controller 418 of the adapter 408 communicates with the machine controller 108 of the work machine 102 via the third cable assembly 426, the second controller 418 communicates with the machine controller 110 of the work machine 104 via the third cable assembly 428, and the second controller 418 communicates with the machine controller 112 of the work machine 106 via the third cable assembly 430. It should be noted that the cable 432 of each third cable assembly 426, 428, 430 may include one or more cables that direct the electric power supply from the adapter 408 to the battery system of the corresponding work machine 102, 104, 106. Moreover, the cable 432 of each third cable assembly 426, 428, 430 may include one or more communication cables that communicably connect the second controller 418 with the machine controller 108, 110, 112 in order to facilitate exchange of information between the second controller 418 and the machine controller 108, 110, 112. A connection between the second controller 418 and the machine controller 108, 110, 112 is illustrated by a dotted line in FIG. 5.

The second controller 418 determines the charging protocol of one of the number of work machines 102, 104, 106 that is currently connected with the adapter 408. Specifically, the second controller 418 receives information of the charging protocol of one of the number of work machines 102, 104, 106 from the machine controller 108, 110, 112 to determine the charging protocol of one of the number of work machines 102, 104, 106. Further, the second controller 418 transmits information of the charging protocol of one of the number of work machines 102, 104, 106 to the first controller 216. Furthermore, the first controller 216 controls the power supply unit 202 to deliver the electric power supply to one of the number of work machines 102, 104, 106 as per the charging protocol of one of the number of work machines 102, 104, 106.

Each of the first controller 216, the second controller 418, and the machine controller 108, 110, 112 may include one or more memories and one or more processors. The one or more memories may include any means of storing information, including a hard disk, an optical disk, a floppy disk, ROM (read only memory), RAM (random access memory), PROM (programmable ROM), EEPROM (electrically erasable PROM), or other computer-readable memory media.

It should be noted that the one or more processors may embody a single microprocessor or multiple microprocessors for receiving various input signals and generating output signals. Numerous commercially available microprocessors may perform the functions of the one or more processors. Each processor may further include a general processor, a central processing unit, an application specific integrated circuit (ASIC), a digital signal processor, a field programmable gate array (FPGA), a digital circuit, an analog circuit, a microcontroller, any other type of processor, or any combination thereof. Each processor may include one or more components that may be operable to execute computer executable instructions or computer code that may be stored and retrieved from the one or more memories.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure relates to the system 200, 400 for charging the number of work machines 102, 104, 106. In one embodiment, the system 200 includes the charging arrangement 204. The charging arrangement 204 includes the number of cable assemblies 206, 208, 210 that allows connection of the power supply unit 202 with the corresponding work machine 102, 104, 106. Further, the first controller 216 may be programmed to adapt to different charging protocols so that the power supply unit 202 can be used to charge work machines manufactured by different manufacturers. Furthermore, the charging arrangement 204 allows charging of any one of the work machines 102, 104, 106 at a given instant of time.

The charging arrangement 204 allows usage of the same power supply unit 202 to charge different types of the work machines 102, 104, 106 by connecting the appropriate cable assembly 206, 208, 210. Thus, customers that employ work machines 102, 104, 106 from different manufacturers in the machine fleet 100 can use the same power supply unit 202 for charging work machines 102, 104, 106 manufactured by different manufacturers that may have different charging protocols. Accordingly, customers may have to purchase only one power supply unit 202. Further, the charging arrangement 204 described herein may eliminate the requirement of having a dedicated charging system for each manufacture's work machine, thereby reducing costs associated with having dedicated charging systems as well as dedicated charging infrastructures for each type of charging system.

In another embodiment, the system 400 includes the charging arrangement 404. The charging arrangement 404 includes the first cable assembly 442 that connects to the power supply unit 202 and the adapter 408. The adapter 408 includes the second cable assembly 420 that connects the first cable assembly 442 with the inlet port 410 and the number of third cable assemblies 426, 428, 430 that connect the outlet port 412, 414, 416 with different work machines 102, 104, 106.

The adapter 408 may be designed to allow charging of multiple work machines 102, 104, 106. For example, any one of the three third cable assemblies 426, 428, 430 may be coupled to the outlet port 412, 414, 416 of the adapter 408 to charge the different work machines 102, 104, 106. Furthermore, the charging arrangement 404 allows charging of any one of the work machines 102, 104, 106 at a given instant of time. The second controller 418 receives the charging protocol of the work machine 102, 104, 106 from the machine controller 108, 110, 112. Further, the second controller 418 transmits information of the charging protocol to the first controller 216. Furthermore, the first controller 216 may be programmed to adapt to different charging protocols so that the power supply unit 202 can be used to charge work machine manufactured by different manufacturers.

The charging arrangement 404 allows usage of the same power supply unit 202 to charge different types of the work machines 102, 104, 106 by connecting the appropriate third cable assembly 426, 428, 430 with the adapter 408. Thus, customers that employ work machines 102, 104, 106 from different manufacturers in the machine fleet 100 can use the same power supply unit 202 for charging work machines 102, 104, 106 manufactured by different manufacturers that may have different charging protocols. Accordingly, customers may have to purchase only one power supply unit 202. Further, the charging arrangement 404 described herein may eliminate the requirement of having a dedicated charging system for each manufacture's work machine, thereby reducing costs associated with having dedicated charging systems as well as dedicated charging infrastructures for each type of charging system.

The system 200, 400 provides a simple and cost-effective solution of charging multiple work machines 102, 104, 106 having different charging protocols. Further, the system 200, 400 can be easily implemented on existing charging systems with minimum modifications.

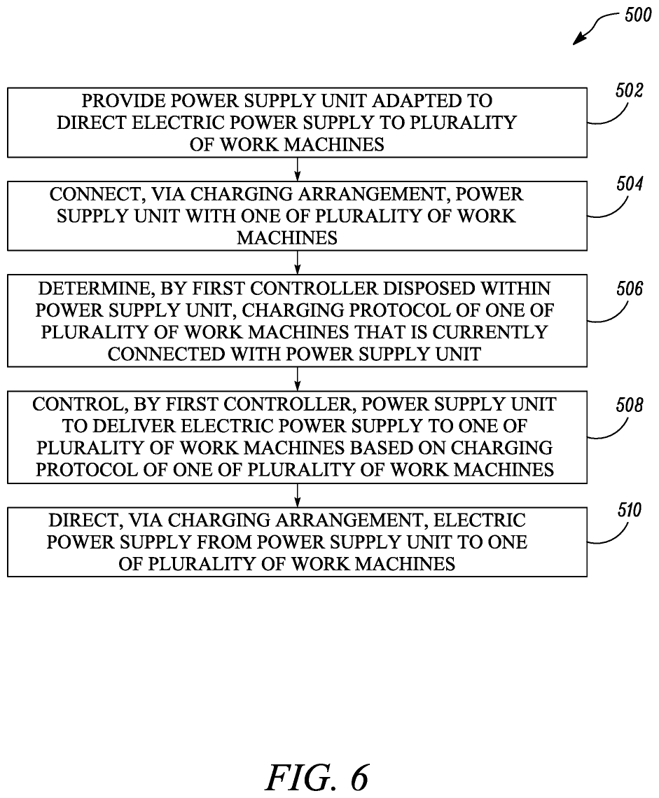

FIG. 6 is a flowchart for a method 500 of charging the number of work machines 102, 104, 106. At least some of the number of work machines 102, 104, 106 have different charging protocols. Referring to FIGS. 1 to 5, at step 502, the power supply unit 202 is provided to direct the electric power supply to the number of work machines 102, 104, 106.

At step 504, the power supply unit 202 is connected with one of the number of work machines 102, 104, 106 from the number of work machines 102, 104, 106 via the charging arrangement 204, 404.

In one embodiment, the charging arrangement 204 includes the number of cable assemblies 206, 208, 210. At a given instant of time, one of the number of work machines 102, 104, 106 from the number of work machines 102, 104, 106 is connected with the power supply unit 202 via the corresponding cable assembly 206, 208, 210 from the number of cable assemblies 206, 208, 210 to direct the electric power supply from the power supply unit 202 to one of the number of work machines 102, 104, 106.

In another embodiment, the charging arrangement 404 includes the adapter 408. The adapter 408 includes the housing 409, the inlet port 410 defined in the housing 409, and the number of outlet ports 412, 414, 416 defined in the housing 409. The power supply unit 202 connects with the adapter 408 at the inlet port 410. The adapter 408 connects with each of the number of work machines 102, 104, 106 via the corresponding outlet port 412, 414, 416 from the number of outlet ports 412, 414, 416.

When the charging arrangement 204 includes the number of cable assemblies 206, 208, 210, each of the number of cable assemblies 206, 208, 210 includes the cable 212 and the electric connector 214. The step 504 further includes connecting the cable 212 with one of the number of work machines 102, 104, 106 via the electric connector 214.

When the charging arrangement 404 includes the adapter 408, the charging arrangement 404 further includes the first cable assembly 442 that connects with the power supply unit 202. The first cable assembly 442 includes the cable 444 and the electric connector 446. The adapter 408 further includes the second cable assembly 420 that connects the inlet port 410 of the adapter 408 with the first cable assembly 442. The second cable assembly 420 includes the cable 422 and the electric connector 424. The step 504 further includes connecting the first cable assembly 442 with the second cable assembly 420.

The adapter 408 further includes the number of third cable assemblies 426, 428, 430. The one or more work machines 102, 104, 106 is connected with the corresponding outlet port 412, 414, 416 of the adapter 408 via the corresponding third cable assembly 426, 428, 430 from the number of third cable assemblies 426, 428, 430. The second controller 418 of the adapter 408 communicates with the machine controller 108, 110, 112 of the number of work machines 102, 104, 106 via the corresponding third cable assembly 426, 428, 430. Each of the number of third cable assemblies 426, 428, 430 includes the cable 432 and the electric connector 434. The step 504 further includes connecting the third cable assembly 426, 428, 430 with one of the number of work machines 102, 104, 106 and the corresponding outlet port 412, 414, 416 of the adapter 408.

At step 506, the first controller 216 disposed within the power supply unit 202 determines the charging protocol of one of the number of work machines 102, 104, 106 that is currently connected with the power supply unit 202. The first controller 216 determines the charging protocol of one of the number of work machines 102, 104, 106 via the charging arrangement 204, 404.

At step 508, the first controller 216 controls the power supply unit 202 to deliver the electric power supply to one of the number of work machines 102, 104, 106 based on the charging protocol of one of the number of work machines 102, 104, 106.

At step 510, the electric power supply from the power supply unit 202 is directed to one of the number of work machines 102, 104, 106 via the charging arrangement 204, 404.

The adapter 408 further includes the second controller 418 disposed in the housing 409. The second controller 418 is communicably coupled with the first controller 216 and the number of work machines 102, 104, 106. The method 500 further includes a step at which the second controller 418 determines the charging protocol of one of the number of work machines 102, 104, 106 from the number of work machines 102, 104, 106 that is currently connected with the adapter 408. Further, the method 500 also includes a step at which the second controller 418 transmits the information of the charging protocol of one of the number of work machines 102, 104, 106 that is currently connected with the adapter 408 to the first controller 216. The first controller 216 determines the charging protocol of one of the number of work machines 102, 104, 106 based on information of the charging protocol transmitted by the second controller 418.

Further, the work machine 102, 104, 106 includes the machine controller 108, 110, 112. The second controller 418 of the adapter 408 communicates with the machine controller 108, 110, 112 of the number of work machines 102, 104, 106. The method 500 further includes a step at which the second controller 418 receives the information of the charging protocol of one of the number of work machines 102, 104, 106 from the machine controller 108, 110, 112 to determine the charging protocol of one of the number of work machines 102, 104, 106.

The method 500 further includes a step at which the battery 438 of the adapter 408 receives the power supply from the power supply unit 202 to recharge the battery 438 upon connecting the power supply unit 202 with the adapter 408. The method 500 further includes a step at which the battery 438 directs the operating power supply to the second controller 418 for operation thereof.

Further, when the charging arrangement 204 includes the number of cable assemblies 206, 208, 210, the method 500 includes a step at which the first controller 216 determines the connection of one of the number of work machines 102, 104, 106 with the power supply unit 202 via the corresponding cable assembly 206, 208, 210 from the number of cable assemblies 206, 208, 210. The method 500 further includes a step at which the first controller 216 determines the charging protocol of the work machine 102, 104, 106 that is currently connected with the power supply unit 202. The method 500 further includes a step at which the first controller 216 configures the electric power supply to the work machine 102, 104, 106 that is currently connected with the power supply unit 202 as per the charging protocol of the work machine 102, 104, 106.

Furthermore, the work machine 102, 104, 106 includes the machine controller 108, 110, 112. When the charging arrangement 204 includes the number of cable assemblies 206, 208, 210, the first controller 216 of the power supply unit 202 communicates with the machine controller 108, 110, 112 of each work machine 102, 104, 106 via the corresponding cable assembly 206, 208, 210. The method 500 further includes a step at which the first controller 216 receives the information of the charging protocol of one of the work machines 102, 104, 106 from the machine controller 108, 110, 112 to determine the charging protocol of the work machine 102, 104, 106 that is currently connected with the power supply unit 202.

While aspects of the present disclosure have been particularly shown and described with reference to the embodiments above, it will be understood by those skilled in the art that various additional embodiments may be contemplated by the modification of the disclosed work machine, systems and methods without departing from the spirit and scope of the disclosure. Such embodiments should be understood to fall within the scope of the present disclosure as determined based upon the claims and any equivalents thereof.

What is claimed is:

1. A system for charging a plurality of work machines, wherein at least some of the plurality of work machines have different charging protocols, the system comprising:
a power supply unit adapted to direct an electric power supply to the plurality of work machines;
a first controller disposed within the power supply unit and configured to control the power supply unit to deliver the electric power supply to one of the plurality of work machines based on the charging protocol of one of the plurality of work machines; and
a charging arrangement adapted to direct the electric power supply from the power supply unit to the plurality of work machines, wherein the charging arrangement includes any one of:
a plurality of cable assemblies, wherein, at a given instant of time, one of the plurality of work machines is adapted to be connected with the power supply unit via a corresponding cable assembly from the plurality of cable assemblies to direct the electric power supply from the power supply unit to one of the plurality of work machines; and
an adapter including:
a housing;
an inlet port defined in the housing, wherein the power supply unit connects with the adapter via the inlet port;
a plurality of outlet ports defined in the housing, wherein the adapter is adapted to connect with each of the plurality of work machines via a corresponding outlet port from the plurality of outlet ports; and
a second controller disposed in the housing, wherein the second controller is communicably coupled with the first controller and the plurality of work machines, and wherein the second controller is configured to:
determine the charging protocol of one of the plurality of work machines that is currently connected with the adapter; and
transmit information of the charging protocol of one of the plurality of work machines to the first controller, wherein the first controller is configured to control the power supply unit to deliver the electric power supply to one of the plurality of work machines as per the charging protocol of one of the plurality of work machines.

2. The system of claim 1, wherein each of the plurality of cable assemblies includes a cable and an electric connector, and wherein the cable is adapted to be connected with a corresponding work machine from the plurality of work machines via the electric connector.

3. The system of claim 2, wherein a type of the electric connector of each of the plurality of cable assemblies is selected as per the charging protocol of the corresponding work machine.

4. The system of claim 1, wherein, when the charging arrangement includes the plurality of cable assemblies, the first controller is configured to:
determine a connection of one of the plurality of work machines with the power supply unit via a corresponding cable assembly from the plurality of cable assemblies;
determine the charging protocol of the work machine that is currently connected with the power supply unit; and
configure the electric power supply to the work machine that is currently connected with the power supply unit as per the charging protocol of the work machine.

5. The system of claim 4, wherein each of the plurality of work machines includes a machine controller, wherein the first controller of the power supply unit is configured to communicate with the machine controller of each work machine via the corresponding cable assembly, and wherein the first controller is configured to receive information of the charging protocol of each work machine from the machine controller to determine the charging protocol of each work machine.

6. The system of claim 1, wherein, when the charging arrangement includes the adapter, the charging arrangement further includes a first cable assembly that connects with the power supply unit, wherein the first cable assembly includes a cable and an electric connector, wherein the adapter further includes a second cable assembly that connects the inlet port of the adapter with the first cable assembly, and wherein the second cable assembly includes a cable and an electric connector.

7. The system of claim 1, wherein the adapter further includes a plurality of third cable assemblies, wherein at least one work machine from the plurality of work machines is connected with the corresponding outlet port of the adapter via a corresponding third cable assembly from the plurality of third cable assemblies, and wherein each of the plurality of third cable assemblies includes a cable and an electric connector.

8. The system of claim 7, wherein a type of the electric connector of each of the plurality of third cable assemblies is selected as per the charging protocol of a corresponding work machine from the plurality of work machines.

9. The system of claim 7, wherein each of the plurality of work machines includes a machine controller, wherein the second controller of the adapter is configured to communicate with the machine controller of the plurality of work machines via the corresponding third cable assembly, and wherein the second controller is configured to receive information of the charging protocol of one of the plurality of work machines from the machine controller to determine the charging protocol of one of the plurality of work machines.

10. The system of claim 1, wherein the adapter further includes a battery configured to direct an operating power supply to the second controller for operation thereof, and wherein the battery is recharged based on receipt of a power supply from the power supply unit upon connecting the power supply unit with the adapter.

11. The system of claim 1, wherein the power supply unit includes any one of a 48 Volts (V) direct current (DC) charger, a 72 V DC charger, and a 96 V DC charger.

12. A method of charging a plurality of work machines, wherein at least some of the plurality of work machines have different charging protocols, the method comprising:
providing a power supply unit adapted to direct an electric power supply to the plurality of work machines;
connecting, via a charging arrangement, the power supply unit with one of the plurality of work machines, wherein the charging arrangement includes any one of:
a plurality of cable assemblies, wherein, at a given instant of time, one of the plurality of work machines from the plurality of work machines is adapted to be connected with the power supply unit via a corresponding cable assembly from the plurality of cable assemblies to direct the electric power supply from the power supply unit to one of the plurality of work machines; and
an adapter including a housing, an inlet port defined in the housing, and a plurality of outlet ports defined in the housing, wherein the power supply unit connects with the adapter at the inlet port, and wherein the adapter is adapted to connect with each of the plurality of work machines via a corresponding outlet port from the plurality of outlet ports; and
determining, by a first controller disposed within the power supply unit, the charging protocol of one of the plurality of work machines that is currently connected with the power supply unit, wherein the first controller is configured to determine the charging protocol of one of the plurality of work machines via the charging arrangement;
controlling, by the first controller, the power supply unit to deliver the electric power supply to one of the plurality of work machines based on the charging protocol one of the plurality of work machines; and
directing, via the charging arrangement, the electric power supply from the power supply unit to one of the plurality of work machines.

13. The method of claim 12, wherein, when the charging arrangement includes the adapter, the charging arrangement further includes a first cable assembly that connects with the power supply unit, wherein the first cable assembly includes a cable and an electric connector, wherein the adapter further includes a second cable assembly that connects the inlet port of the adapter with the first cable assembly, wherein the second cable assembly includes a cable and an electric connector, and wherein the step of connecting, via the charging arrangement, the power supply unit with one of the plurality of work machines further includes connecting the first cable assembly with the second cable assembly.

14. The method of claim 12, wherein the adapter further includes a second controller disposed in the housing, the second controller is configured to be communicably coupled with the first controller and the plurality of work machines, the method further comprising:
determining, by the second controller, the charging protocol of one of the plurality of work machines that is currently connected with the adapter; and
transmitting, by the second controller, information of the charging protocol of one of the plurality of work machines to the first controller, wherein the first controller is configured to determine the charging protocol of one of the plurality of work machines that is currently connected with the adapter based on information of the charging protocol transmitted by the second controller.

15. The method of claim 14, wherein each of the plurality of work machines includes a machine controller, and wherein the second controller of the adapter is configured to communicate with the machine controller of the plurality of work machines, the method further comprising receiving, by the second controller, information of the charging protocol of one of the plurality of work machines from the machine controller to determine the charging protocol of one of the plurality of work machines.

16. The method of claim 15, wherein the adapter further includes a plurality of third cable assemblies, wherein at least one work machine is connected with the corresponding outlet port of the adapter via a corresponding third cable assembly from the plurality of third cable assemblies, wherein the second controller of the adapter is configured to communicate with the machine controller of the plurality of work machines via the corresponding third cable assembly, wherein each of the plurality of third cable assemblies includes a cable and an electric connector, and wherein the step of connecting, via the charging arrangement, the power supply unit with one of the plurality of work machines further includes connecting the third cable assembly with one of the plurality of work machines and a corresponding outlet port of the adapter.

17. The method of claim 14 the method further comprising:
receiving, by a battery of the adapter, a power supply from the power supply unit to recharge the battery upon connecting the power supply unit with the adapter; and
providing, by the battery, an operating power supply to the second controller for operation thereof.

18. The method of claim 12, wherein, when the charging arrangement includes the plurality of cable assemblies, each of the plurality of cable assemblies includes a cable and an electric connector, and wherein the step of connecting, via the charging arrangement, the power supply unit with one of the plurality of work machines further includes connecting the cable with one of the plurality of work machines via the electric connector.

19. The method of claim 12, wherein, when the charging arrangement includes the plurality of cable assemblies, the method further comprises:
determining, by the first controller, a connection of one of the plurality of work machines from the plurality of work machines with the power supply unit via a corresponding cable assembly from the plurality of cable assemblies;
determining, by the first controller, the charging protocol of the work machine that is currently connected with the power supply unit; and
configuring, by the first controller, the electric power supply to the work machine that is currently connected with the power supply unit as per the charging protocol of the work machine.

20. The method of claim 19, wherein each of the plurality of work machines includes a machine controller, and wherein, when the charging arrangement includes the plurality of cable assemblies, the first controller of the power supply unit is configured to communicate with the machine controller of each work machine via the corresponding cable assembly, the method further comprising receiving, by the first controller, information of the charging protocol of one of the work machines from the machine controller to determine the charging protocol of the work machine that is currently connected with the power supply unit.
